(19) United States
(12) Patent Application Publication
(10) Pub. No.: US 2026/0332404 A1
(43) Pub. Date: Oct. 22, 2026

(54) LOWER LAYER SECURITY KEY DERIVATION

(71) Applicant: Lenovo (United States) Inc., Morrisville, NC (US)

(72) Inventors: Andreas Kunz, Ladenburg (DE); Prateek Basu Mallick, Dreieich (DE); Joachim Löhr, Wiesbaden (DE); Shwetha Sreejith, Steinbach (DE); Sheeba Backia Mary Baskaran, Friedrichsdorf (DE)

(73) Assignee: Lenovo (United States) Inc., Morrisville, NC (US)

(21) Appl. No.: 19/269,983

(22) Filed: Jul. 15, 2025

(51) Int. Cl. H04L 9/08; H04L 9/32

(52) U.S. Cl. CPC H04L 9/0861; H04L 9/32

(57) ABSTRACT

Various aspects of the present disclosure relate to lower layer security key generation. A network entity (NE) detects that an updated security key is available and generates, using the updated security key, at least one lower layer security key. The NE transmits, to a user equipment (UE), a lower layer message using the at least one lower layer security key. The UE detects that the updated security key is available and generates, using the updated security key, the at least one lower layer security key. The UE uses the at least one lower layer security key to receive the lower layer message. In some examples, the at least one lower layer security key includes a first lower layer security key for ciphering and a second lower layer security key for integrity protection. In some examples, the updated security key is an updated next generation NodeB (gNB) security key.

### TECHNICAL FIELD

The present disclosure relates to wireless communications, and more specifically to security mechanisms for lower layer messages.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to detect that an updated security key is available, generate, using the updated security key, at least one lower layer security key for protection of lower layer messages, and receive a lower layer message using the at least one lower layer security key.

A processor (e.g., a standalone processor chipset, or a component of a UE) for wireless communication is described. The processor may be configured to, capable of, or operable to perform one or more operations as described herein. For example, the processor may be configured to, capable of, or operable to detect that an updated security key is available, generate, using the updated security key, at least one lower layer security key for protection of lower layer messages, and receive a lower layer message using the at least one lower layer security key.

A method performed or performable by a UE for wireless communication is described. The method may include detecting that an updated security key is available, generating, using the updated security key, at least one lower layer security key for protection of lower layer messages, and receiving a lower layer message using the at least one lower layer security key.

In some implementations, to generate the at least one lower layer security key, the UE, the processor, and the method may further be configured to, capable of, or operable to provide, as inputs to a key derivation function, one or more of a function code (FC) value, a lower layer flag, a length of the lower layer flag, an algorithm type distinguisher, or a length of the algorithm type distinguisher, and derive the at least one lower layer security key from the updated security key using the key derivation function.

In some implementations, the at least one lower layer security key comprises a first lower layer security key and a second lower layer security key, and to generate the at least one lower layer security key, the UE, the processor, and the method may further be configured to, capable of, or operable to generate a first lower layer security key using a first algorithm type distinguisher and a first length of the first algorithm type distinguisher, and generate a second lower layer security key using a second algorithm type distinguisher and a second length of the second algorithm type distinguisher. In some implementations, to receive the lower layer message, the UE, the processor, and the method may further be configured to, capable of, or operable to decrypt the lower layer message using the first lower layer security key, and verify authenticity of the lower layer message using the second lower layer security key.

In some implementations, the at least one lower layer security key comprises a single lower layer security key, and to receive the lower layer message, the UE, the processor, and the method may further be configured to, capable of, or operable to decrypt the lower layer message using the single lower layer security key, and verify authenticity of the lower layer message using the single lower layer security key.

In some implementations, the UE, the processor, and the method may further be configured to, capable of, or operable to generate the at least one lower layer security key separately from a procedure for radio resource control (RRC) and user plane (UP) key generation.

In some implementations, the UE, the processor, and the method may further be configured to, capable of, or operable to generate the at least one lower layer security key as part of a procedure for RRC and UP key generation.

In some implementations, the UE, the processor, and the method may further be configured to, capable of, or operable to generate the at least one lower layer security key based at least in part on a determination that a medium access control (MAC) security feature is enabled at the UE.

In some implementations, the UE, the processor, and the method may further be configured to, capable of, or operable to use an updated next generation NodeB (gNB) security key as the updated security key.

An NE (e.g., a base station) for wireless communication is described. The NE may be configured to, capable of, or operable to perform one or more operations as described herein. For example, the NE may be configured to, capable of, or operable to detect that an updated security key is available, generate, using the updated security key, at least one lower layer security key for protection of lower layer messages, and transmit a lower layer message using the at least one lower layer security key.

A processor (e.g., a standalone processor chipset, or a component of an NE) for wireless communication is described. The processor may be configured to, capable of, or operable to perform one or more operations as described herein. For example, the processor may be configured to, capable of, or operable to detect that an updated security key is available, generate, using the updated security key, at least one lower layer security key for protection of lower layer messages, and transmit a lower layer message using the at least one lower layer security key.

A method performed or performable by an NE (e.g., a base station) for wireless communication is described. The method may include detecting that an updated security key is available, generating, using the updated security key, at least one lower layer security key for protection of lower layer messages, and transmitting a lower layer message using the at least one lower layer security key.

In some implementations, to generate the at least one lower layer security key, the NE, the processor, and the method may further be configured to, capable of, or operable to derive the at least one lower layer security key from the updated security key using a key derivation function. In some implementations, to derive the at least one lower layer security key, the NE, the processor, and the method may further be configured to, capable of, or operable to provide, as inputs to the key derivation function, one or more of an FC value, a lower layer flag, a length of the lower layer flag, an algorithm type distinguisher, or a length of the algorithm type distinguisher.

In some implementations, the at least one lower layer security key comprises a first lower layer security key and a second lower layer security key, and, to generate the at least one lower layer security key, the NE, the processor, and the method may further be configured to, capable of, or operable to generate a first lower layer security key using a first algorithm type distinguisher and a first length of the first algorithm type distinguisher, and generate a second lower layer security key using a second algorithm type distinguisher and a second length of the second algorithm type distinguisher. In some implementations, to transmit the lower layer message, the NE, the processor, and the method may further be configured to, capable of, or operable to encrypt the lower layer message using the first lower layer security key, and integrity protect the lower layer message using the second lower layer security key.

In some implementations, the at least one lower layer security key comprises a single lower layer security key, and, to transmit the lower layer message, the NE, the processor, and the method may further be configured to, capable of, or operable to encrypt the lower layer message using the single lower layer security key, and integrity protect the lower layer message using the single lower layer security key.

In some implementations, the NE, the processor, and the method may further be configured to, capable of, or operable to generate the at least one lower layer security key separately from a procedure for RRC and UP key generation.

In some implementations, the NE, the processor, and the method may further be configured to, capable of, or operable to generate the at least one lower layer security key as part of a procedure for RRC and UP key generation.

In some implementations, the NE, the processor, and the method may further be configured to, capable of, or operable to generate the at least one lower layer security key based at least in part on a determination that a MAC security feature is enabled at the NE.

In some implementations, the NE, the processor, and the method may further be configured to, capable of, or operable to use an updated gNB security key as the updated security key.

### BRIEF DESCRIPTION OF THE DRAWINGS

FIG. 1 illustrates an example of a wireless communications system in accordance with aspects of the present disclosure.

FIG. 2 illustrates an example of a security flow in accordance with aspects of the present disclosure.

FIG. 3 illustrates an example of a key hierarchy in accordance with aspects of the present disclosure.

FIG. 4 illustrates an example of a process flow in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by an NE in accordance with aspects of the present disclosure.

FIG. 9 illustrates a flowchart of a method performed by a UE in accordance with aspects of the present disclosure.

### DETAILED DESCRIPTION

In a wireless communications system, a UE communicates with a network by exchanging signaling with one or more NEs (e.g., network nodes, gNBs, base stations, and the like). The UE and the NE(s) may perform procedures that rely on lower layer messages (e.g., Layer 1/Layer 2 (L1/L2) messages), such as MAC control elements (MAC-CEs) and physical layer (PHY layer) information. MAC-CEs and PHY layer information can include information such as timing advance (TA) commands, power control adjustments, beam management feedback (e.g., cell identifiers (IDs), beam IDs, measurement results), channel state information (CSI), various identification parameters (e.g., logical channel group (LCG) IDs, cell radio network temporary identifiers (C-RNTIs), UE contention resolution IDs, TA group (TAG) IDs), and handover commands, among other examples.

In some wireless communications systems, however, protection of such lower layer messages may be lacking. For example, conventional security procedures (e.g., security key generation) are limited to higher layers, such as packet data convergence protocol (PDCP) layers, and no security context is available for lower layer information. If lower layer messages are not transferred securely, the information included in the lower layer messages may be altered by a malicious device. In such scenarios, devices may accept or otherwise utilize altered parameters in lower layer procedures, which can cause service interruptions (e.g., security negotiation failure, timing misalignment, key mismatch between devices, etc.) and degrade user experience. A malicious device may also spoof lower layer messages or use the information to launch a denial of service (DoS) attack. Additionally, or alternatively, some lower layer information can compromise user privacy and identity.

Accordingly, the techniques described herein provide security procedures for lower layers and mechanisms for lower layer security key generation. A device (e.g., a UE, an NE) may use an existing security key to generate a lower layer security key used for protection of lower layer messages, such as MAC-CEs and/or PHY layer information. The device may generate the lower layer security key upon detection that an updated version of the existing security key is available. As an example, an NE may generate a lower layer security key based on a gNB security key K_{gNB}. The NE may encrypt and integrity protect a lower layer message using the generated lower layer security key before transmitting the lower layer message to a UE. The UE may also generate a lower layer security key based on K_{gNB}. Upon receiving the lower layer message, the UE may use its own generated lower layer security key to decrypt the lower layer message and verify its authenticity. In some examples, the NE and the UE may generate multiple lower layer security keys for the lower layer message, such as a first lower layer security key for ciphering and a second lower layer security key for integrity protection. The lower layer security key generation may be performed separately from or as part of existing radio resource control (RRC) and user plane (UP) key generation procedures.

The described techniques provide protection for vulnerable lower layer communications, improving system security and integrity and ensuring user privacy. For example, by generating and using dedicated lower layer security keys, devices in the wireless communications system can safeguard against unauthorized access, tampering, and spoofing of sensitive information exchanged at lower protocol layers. Further, by protecting lower layer information, the devices can prevent service interruption resulting from malicious attackers, improving communications reliability and avoiding negative user experiences. Additionally, the described techniques provide flexibility by supporting lower layer security key generation either separately or as part of existing key generation procedures may allow for efficient integration into current network architectures without significant overhead.

A number of implementations have been described. Nevertheless, it will be understood that various modifications may be made without departing from the spirit and scope of the disclosure. Accordingly, other implementations are within the scope of the following claims.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

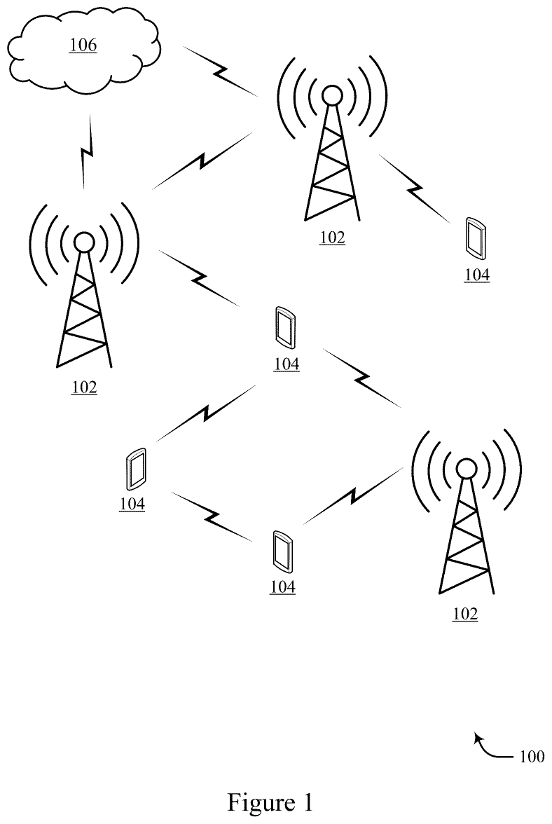

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., ρ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Devices (e.g., UEs 104, NEs 102) in the wireless communications system 100 may operate according to a protocol stack that includes multiple layers that each define a different communication protocol or function. The multiple layers may include one or more of a physical (PHY) layer, a MAC layer, a radio link control (RLC) layer, a PDCP layer, an RRC layer, a service data adaptation protocol (SDAP) layer, a session management (SM) layer, and a non-access stratum (NAS) layer. The layers of protocol stack may be grouped into L1, L2, and Layer 3 (L3). L1 and L2 may include at least the PHY layer and the MAC layer and may be known as lower layers of the protocol stack. The NAS, RRC, and PDCP layers may be referred to as upper layers. Messages and/or data processed at the lower layers, such as MAC-CEs and PHY information, may be referred to as lower layer messages. For example, PHY layer information may be carried in downlink control information (DCI) or in uplink information.

In some examples, devices of the wireless communications system 100 (e.g., the UE 104 and/or the NE 102) may perform procedures that rely on the exchange of lower layer messages. For example, the devices may perform L1/L2 triggered mobility. During L1/L2 triggered mobility, the NE 102 may receive a measurement report (e.g., an L1 measurement report) from the UE 104. Based on the measurement report, the NE 102 may transmit a cell switch command for the UE 104 to change its serving cell via a lower layer message (e.g., a MAC-CE message). The cell switch command may include MAC-CE(s) carrying parameters such as a TA command, a target configuration ID, and the like. Other examples of parameters included in lower layer messages include an LCG ID, a C-RNTI, a UE contention resolution ID, a TAG ID, etc.

Conventionally, no security context is available for lower layer messages and is only available for access stratum (AS) security in RRC and/or PDCP layers. A security context may be defined as a set of security-related parameters and keys, such as those associated with a UE-specific connection. A security context may include, for example, one or more security keys, one or more algorithm identifiers (e.g., for ciphering algorithms and integrity algorithms), one or more sequence numbers, radio bearer IDs, quality of service (QoS) flow IDs, and the like. In some examples, a security context may include an indication of an activation status for encryption and/or integrity protection features. For instance, the security context may indicate that an encryption and/or integrity protection feature is active or inactive for a UE 104. Security contexts may be stored at a network node and the UE 104.

Without security available at lower layers, lower layer messages may not be protected and are therefore susceptible to attacks by malicious devices. For example, malicious devices may tamper with or monitor one or more parameters of the lower layer messages. Tampering with such parameters can jeopardize the connection between the UE 104 and the NE 102, causing service interruptions. Monitoring such parameters can enable an attacker to access or otherwise surmise personal information of a user of the UE 104, such as the user's location.

The techniques described herein provide protection of lower layer messages through lower layer security key generation. For example, an NE 102 and/or a UE 104 can generate one or more lower layer security keys using a key derivation function (KDF), which receives, as input parameters, one or more of an FC, a lower layer flag, a length of the lower layer flag, an algorithm type distinguisher, a length of the algorithm type distinguisher, and/or an input key. In some examples, the input key is an updated or “new” version of an existing security key, such as KgNB). In some cases, separate lower layer security keys are generated for ciphering and integrity protection. In such cases, the at least one lower layer security key includes a lower layer cipher key (CK) and a lower layer integrity key (IK). Additionally, or alternatively, a single lower layer security key can be used for both ciphering and integrity protection (e.g., the lower layer security key acts as both a CK and an IK).

According to implementations, one or more of the NEs 102 and the UEs 104 are operable to implement various aspects of the techniques described with reference to the present disclosure. For example, upon detection that an updated version of the existing security key is available, an NE 102 and a UE 104 each generate a respective lower layer security key using the updated version of the existing security key. The NE 102 and/or the UE 104 utilize the one or more lower layer security keys to protect lower layer messages exchanged with one another. For example, the NE 102 can encrypt and integrity protect a MAC-CE (e.g., a message containing a MAC-CE) transmitted to the UE 104 using the at least one lower layer security key generated by the NE 102. The UE 104 can utilize the at least one lower layer security key generated by the UE 104 to decrypt and verify authenticity of the MAC-CE received from the NE 102.

The techniques as described herein may be applicable to any procedure that relies on lower layer messages. For example, the techniques as described herein may be performed as part of L1/L2 triggered mobility or any other procedure that relies on lower layer signaling.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

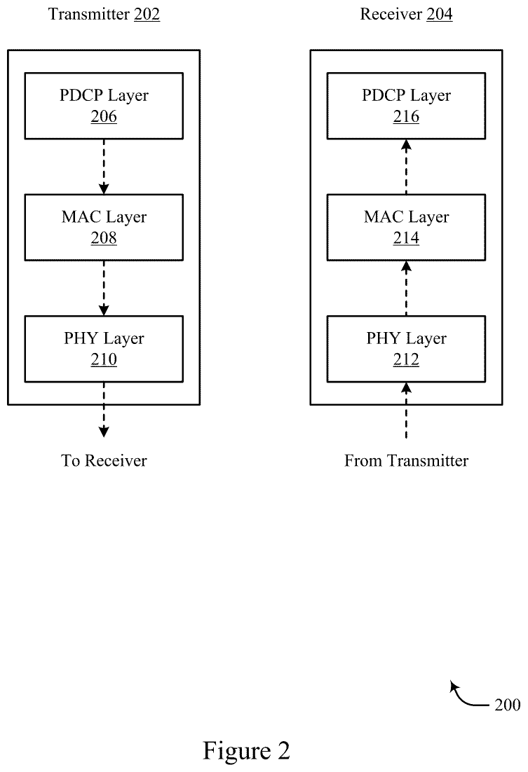

FIG. 2 illustrates an example of a security flow 200 in accordance with aspects of the present disclosure. In some examples, the security flow 200 implements or is implemented by aspects of the wireless communications system 100. For example, the security flow 200 illustrates protocol stack layers in a transmitter 202 and a receiver 204, each of which may include or be an example of an NE 102 or a UE 104 as described with reference to FIG. 1.

The security flow 200 illustrates the protocol stack layers involved in security and protection of data transmissions from the transmitter 202 to the receiver 204. As illustrated, the transmitter 202 includes a PDCP layer 206, a MAC layer 208, and a PHY layer 210. The PDCP layer 206 performs encryption and integrity protection of data before passing it to the MAC layer 208. The MAC layer 208 processes the data received from the PDCP layer 206 and manages resource allocation, multiplexing, and timing control. The MAC layer 208 passes the data to the PHY layer 210, which prepares the data for transmission by performing modulation, coding, and signal processing.

The receiver 204 includes a PHY layer 212, a MAC layer 214, and a PDCP layer 216. Upon reception of the data transmission from the transmitter 202, the PHY layer 212 processes, demodulates, and decodes the data before passing it to the MAC layer 214. The MAC layer 214 manages demultiplexing, error detection, and feedback, and passes the data to the PDCP layer 216. The PDCP layer 216 performs decryption and integrity verification of the data and delivers it to upper layers of the receiver 204.

In conventional systems, security procedures (e.g., ciphering and integrity protection) are limited to upper layers, such as PDCP and RRC layers. Thus, in such systems, information generated or added to a data transmission by lower layers, such as MAC and PHY layers, is left vulnerable to and unprotected from attackers or malicious devices. For instance, L1/L2 information (e.g., MAC-CE parameters) may be generated relatively late in the data processing procedure, such as after an uplink grant is available for the data transmission at a UE, and may therefore be transmitted without protection. MAC-CE parameters, when not transferred securely between devices, may be vulnerable to security threats that can compromise the integrity, confidentiality, and availability of wireless communications. Malicious actors may intercept, monitor, modify, or inject MAC-CE messages, disrupting network operations and compromising user privacy.

As an example, an attacker may tamper with TA commands contained in MAC-CEs, which are used by a UE to synchronize with a service cell of a network. By altering TA values, the attacker may cause timing misalignment between the UE and the network, leading to degraded performance or even connection failures. This may result in dropped calls, reduced data throughput, or increased power consumption for the UE as it attempts to maintain synchronization with the network. Additionally, or alternatively, a malicious actor can alter parameters of a cell switch command MAC-CE (e.g., used in L1/L2 mobility procedures), causing desynchronization, key mismatches, or security negotiation failure between the UE and the network.

Beam management feedback, such as cell IDs, beam IDs, and measurement results, may also be targeted if MAC-CEs are not adequately protected. An attacker may modify this information to mislead the network about a UE's actual radio conditions. This may lead to suboptimal beam selection, unnecessary handovers, or preventing the UE from connecting to a best available cell, negatively impacting the quality of service experienced by the user. Similarly, an attacker may modify CSI reports to mislead the network about the actual channel conditions experienced by the UE. Consequently, the UE and the network may select suboptimal modulation and coding schemes or other communication parameters, leading to reduced spectral efficiency and increased error rates in data transmission.

Unsecured MAC-CEs containing power control adjustments may also be exploited by malicious actors. By manipulating these parameters, an attacker may cause the UE to transmit at inappropriate power levels, inducing excessive interference to neighboring cells if the power is set too high, or poor connection quality if set too low. In some scenarios, this could lead to premature battery drain on the UE or reduced coverage. An attacker may modify or inject false handover commands to initiate unnecessary handovers, service interruptions, or even completely disconnect the UE from the network, disrupting user communications and increasing signaling load on the network.

Additionally, or alternatively, an attacker who gains access to identification parameters in L1/L2 information (e.g., LCG ID, C-RNTI, TAG ID, UE contention resolution ID, etc.) may be able to track user movements, compromise user privacy, or impersonate legitimate devices on the network. An attacker can learn about a type of service used by a UE, usage habits, and preferences by accessing an LCG ID. TA values for a UE remain static if the UE is stationary, such that an attacker could deduce a user's home or workplace based on TA values remaining static for a relatively long time period. Similarly, the attacker may determine that the UE is mobile based on detecting frequent updates of TAG ID for the UE and may ascertain the UE's location based on TA fluctuations among neighboring cells. As another example, the attacker can monitor and analyze C-RNTI usage and link this usage with other intercepted parameters to approximate a location of the UE. More precise location information can be surmised if the attacker is able to obtain C-RNTI usage of the UE among multiple network nodes. During random access, the attacker could monitor UE contention resolution IDs to track the UE's access to the network, as well as other information such as network topology, cell deployment locations, and the like, to obtain the UE's location.

To prevent the above scenarios, the techniques described herein support key derivation mechanisms for generating lower layer security keys. To provide security on lower layers, a shared lower layer security key is used to enable devices on both ends of a communication link to perform the same ciphering (encryption) and integrity protection computations. In the example illustrated by FIG. 2, the transmitter 202 and the receiver 204 each generate and use one or more lower layer security keys to encrypt and authenticate lower layer messages exchanged with one another. The transmitter 202 and the receiver 204 each detect when an updated security key (e.g., an updated version of an existing security key) is available. Upon detection, the transmitter 202 and the receiver 204 each generate at least one lower layer security key using the updated security key. The transmitter 202 and the receiver 204 use the at least one lower layer security key to protect lower layer messages, such as MAC-CEs or PHY layer information. The protection may involve encryption, integrity protection, or both.

For example, in the security flow 200, the transmitter 202 may apply an encryption algorithm using the at least one lower layer security key to encrypt and integrity protect data generated and/or received at the MAC layer 208 and/or the PHY layer 210. In some examples, the at least one lower layer security key includes a first lower layer security key for ciphering (e.g., a lower layer CK) and a second lower layer security key for integrity protection (e.g., a lower layer IK), such that the transmitter 202 encrypts the data using the lower layer CK and protects integrity of the data using the lower layer IK. Additionally, or alternatively, the at least one lower layer security key may include a single lower layer security key used for both ciphering and integrity protection. The transmitter 202 transmits a lower layer message including the encrypted, protected data to the receiver 204. Upon reception at the PHY layer 212 and/or the MAC layer 214, the receiver 204 decrypts and verifies the integrity of the data using the at least one lower layer security key.

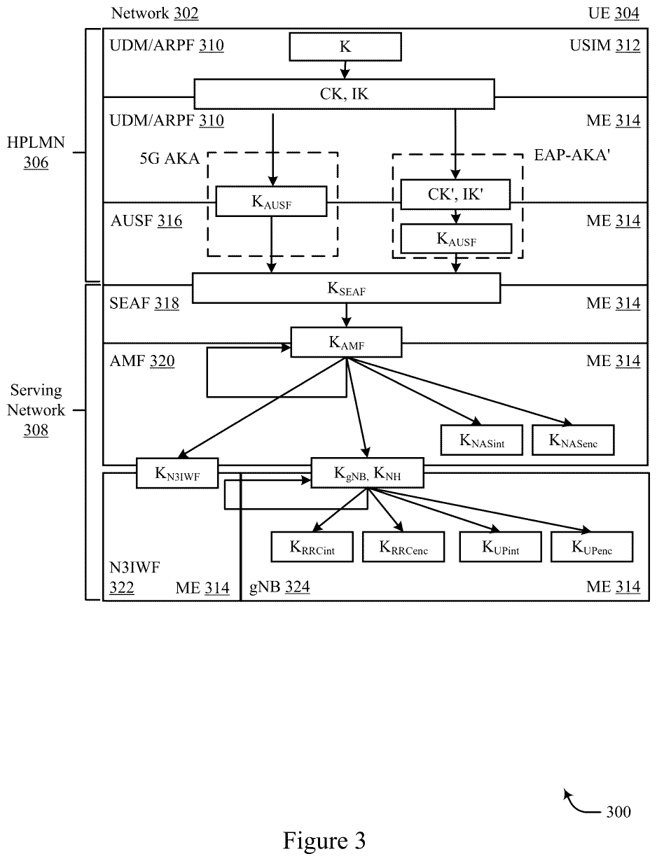

FIG. 3 illustrates an example of a key hierarchy 300 in accordance with aspects of the present disclosure. In some examples, the key hierarchy 300 implements or is implemented by aspects of the wireless communications system 100. For example, the key hierarchy 300 illustrates security key generation at a network 302 and a UE 304, each of which may include or be an example of an NE 102 or a UE 104 as described with reference to FIG. 1.

The key hierarchy 300 illustrates the structure and relationships of security keys used in a wireless communications system, such as the wireless communications system 100. A security key may include or be an example of a string of random bits generated using a KDF. The KDF receives an input string S formed of a set of parameters, which may include, but are not limited to, an input key, an FC, a flag, a flag length, an algorithm type distinguisher, a length of the algorithm type distinguisher, and an algorithm identity. The KDF outputs a security key (e.g., a string of bits) based on the input string S. A transmitter and a receiver each generate (e.g., locally) a security key using the same set of parameters, which enables each device to independently encrypt or decrypt and verify authenticity of a message. Because the security key is not communicated between the devices, an attacker is unable to intercept or otherwise obtain the security key. To provide further protection, security keys may be refreshed (e.g., regenerated) over time.

A transmitter and a receiver can perform encryption/decryption and integrity protection using one or more security keys. In some cases, separate security keys and algorithms are used for encryption and integrity protection, while in other cases, the same security key and one algorithm is used for both encryption and integrity protection. Additionally, security keys generated at different levels of the key hierarchy 300 are generated using respective algorithms. For encryption, a transmitting device combines a security key with additional parameters, such as initialization vectors or nonces, to create a unique keystream for each encryption operation. The keystream may be applied to a plaintext message using a bitwise XOR operation, resulting in ciphertext. Only an intended recipient possessing the same security key and additional parameters can decrypt the ciphertext by generating the same keystream using the security key and performing the reverse XOR operation to recover the original plaintext. Thus, even if an attacker intercepts an encrypted message, they cannot decipher its contents without access to the security key and the additional parameters.

For integrity protection, the transmitter uses a security key and an integrity algorithm to generate a message authentication code, which is appended to a transmitted message. The message authentication code may be a fixed-length bit string computed based on the message content and the security key. The receiver recomputes the message authentication code using the same security key and message content and compares it with the received message authentication code. If they match, the message is verified as authentic and unaltered. This protects against tampering and ensures the transmitter's identity but does not hide the data itself. That is, any unauthorized changes to the message content, such as by an attacker, results in a mismatch between the received message authentication code and that computed by the receiver, alerting the receiver to potential security breaches.

The key hierarchy 300 begins with fundamental keys K, CK, and IK, and progresses downward to specialized keys derived for dedicated purposes. K is a long-term secret key, referred to as a master key, that serves as the root of the key hierarchy 300. K is provisioned during manufacturing or subscriber identity module (SIM) personalization and does not change frequently. K is stored securely in both the UE 304 and the network 302. CK and IK are temporary session keys derived (e.g., by the network 302 and the UE 304) during the authentication process using the master key K and other parameters (e.g., a random challenge RAND). CK may be used for encrypting data to ensure confidentiality of communications between the UE 304 and the network 302. IK may be used to generate message authentication codes that protect the integrity and authenticity of the communications. Thus, the CK is used to protect the confidentiality of data through encryption, while the IK ensures the integrity and authenticity of transmitted information. Additionally, CK and IK may be further used (e.g., by the network 302 and the UE 304) as inputs to derive additional keys for security functions at different protocol layers of the key hierarchy 300.

The network 302 includes a home public land mobile network (HPLMN) 306 and a serving network 308. The HPLMN 306 and the serving network 308 may be the same network or may be different networks. The HPLMN 306 may be referred to as a home network of a subscriber (e.g., the UE 304) and is responsible for authentication and key management. The HPLMN 306 includes a unified data management/authentication credential repository and processing function (UDM/ARPF) 310, which stores and manages long-term security credentials for network subscribers. The UDM/ARPF 310 is responsible for generating authentication vectors and deriving the initial set of security keys (e.g., K, CK, IK). The HPLMN 306 also includes an authentication server function (AUSF) 316, which performs authentication of UEs and derives K_{AUSF} from the authentication vectors provided by the UDM/ARPF 310.

The UE includes a universal subscriber identity module (USIM) 312 and mobile equipment (ME) 314. The USIM 312 is a smart card within the UE 304 that stores subscriber-specific information, such as a unique user identifier and other user data, as well as the master key K. The ME 314 includes the device used by the subscriber (e.g., a smartphone) that includes the USIM 312. The ME 314 performs key derivations and cryptographic operations using the derived keys. Additionally, the ME 314 may perform authentication procedures with the network 302, such as 5G authentication and key agreement (AKA) and extensible authentication protocol for authentication and key agreement (EAP-AKA′). For instance, the ME 314 and the AUSF 316 perform 5G AKA and/or EAP-AKA′ to derive K_{AUSF} (and, in the case of EAP-AKA′, to derive CK′ and IK′) from the initial authentication vectors provided by the UDM/ARPF 310. The K_{AUSF} serves as a root key for subsequent key derivations in the key hierarchy 300. For example, following the successful completion of either 5G AKA or EAP-AKA′, the AUSF 316 derives K_{SEAF} from the K_{AUSF}.

The serving network 308 includes a security anchor function (SEAF) 318 that stores and distributes security-related parameters and keys (e.g., K_{AUSF}, derived keys such as K_{gNB} and K_{NH}), which together may be referred to as a security context. In some examples, security contexts may be stored at the SEAF 318 on a per-UE basis. The SEAF 318 receives K_{SEAF} from the AUSF 316 and derives KAMF using K_{SEAF}. KAMF, in turn, becomes the root key for generating subsequent keys in the key hierarchy 300, such as K_{N3IWF}, K_{gNB}, K_{NH}, and NAS keys (e.g., K_{NASint}, K_{NASenc}).

The serving network 308 further includes an access and mobility management function (AMF) 320, which manages UE registration, connection, and mobility, and handles transfer of security contexts. The AMF 320 receives KAMF from the SEAF 318. The AMF 320 and the ME 314 use KAMF for non-access stratum (NAS) security between the UE 304 and the AMF 320, e.g., by deriving K_{NASint} and K_{NASenc} using KAMF. K_{NASint} and K_{NASenc} are used for the protection of NAS signaling with a corresponding integrity algorithm and encryption algorithm, respectively.

Additionally, the serving network 308 includes a non-3GPP interworking function (N3IWF) 322 and a gNB 324 (e.g., a base station, an NE). The N3IWF 322 is responsible for integrating non-3GPP access networks with the 5G core network. The N3IWF 322 and the ME 314 derive KN3IW, used for securing communications over non-3GPP access. The gNB 324 and the ME 314 derive K_{gNB} and K_{NH} from KAMF. K_{NH} is a next hop (NH) key used during handovers, while K_{gNB} is used to secure the radio interface between the UE 304 and the gNB 324. For example, K_{gNB} is derived by the ME 314 and a source gNB when performing horizontal or vertical key derivation. Additionally, K_{gNB} is used to generate keys for RRC and UP encryption and integrity protection (e.g., K_{RRCenc}, K_{RRCint}, K_{UPenc}, K_{UPint}) between the UE 304 and the gNB 324 using respective encryption and integrity algorithms.

According to the techniques described herein, the network 302 (e.g., the gNB 324) and the UE 304 (e.g., the ME 314) independently generate at least one lower layer security key using a same KDF and inputs. A lower layer security key may be referred to herein as K_{MAC}. K_{MAC} is used in the MAC layer (e.g., of the UE 304 and an NE, such as the gNB 324) for protection of MAC-CE information transmitted between the UE 304 and the gNB 324.

For example, a transmitting device, such as the gNB 324, may generate K_{MAC} using a KDF and may use K_{MAC} to perform encryption and integrity protection of at least one lower layer message (e.g., a MAC-CE) to be transmitted to a receiving device, such as the UE 304. The transmitting device and the receiving device use the same KDF and the same inputs to the KDF. K_{MAC} may be generated based on an existing security key, such as K_{gNB}. The KDF inputs may include, but are not limited to, K_{gNB}, an FC value, a lower layer flag, a length of the lower layer flag, an algorithm identity, a length of the algorithm identity, an algorithm type distinguisher, and a length of the algorithm type distinguisher.

The UE 304 also generates K_{MAC} using the same KDF and inputs. Upon reception of the at least one lower layer message, the UE 304 decrypts and authenticates the at least one lower layer message using K_{MAC}. For example, the UE 304 uses K_{MACenc} and an inverse version of the encryption algorithm to extract the original contents of the lower layer message, and verifies integrity using K_{MACint} to compute the message authentication code. The decrypted and verified message can then be processed by the appropriate protocol layers at the UE 304.

In some cases, K_{MAC} can be refreshed over time, such as when a new (e.g., updated, refreshed) version of K_{gNB} is available. For example, the UE 304 and the gNB 324 may generate K_{MAC} upon detection of an updated K_{gNB}. Additionally, or alternatively, the UE 304 and the gNB 324 generate K_{MAC} based on detecting that a lower layer security feature (e.g., a MAC security feature) is enabled (e.g., supported, activated). The UE 304 may activate or deactivate MAC security based on receiving a security mode command from the gNB 324. The security mode command may specify the algorithms (e.g., encryption and/or integrity algorithms) for use in generating K_{MAC}. The UE 304 may generate K_{MAC} each time a new K_{gNB} is available and when MAC security is supported. For example, upon detection of an updated K_{gNB}, the UE 304 may determine whether MAC security is enabled at the UE 304; if so, the UE 304 may generate K_{MAC}.

In some implementations, a single K_{MAC} and algorithm may be used for both encryption and integrity protection, while in other implementations, separate K_{MAC}s and algorithms may be used for separate encryption and integrity protection procedures (e.g., K_{MACenc} and K_{MACint}, respectively, and an encryption algorithm and an integrity algorithm, respectively). To encrypt a lower layer message, the gNB 324 combines K_{MACenc} with additional parameters to generate a keystream. The keystream is XORed with contents of the lower layer message to produce ciphertext. Only receiving devices possessing the same K_{MACenc} and the same additional parameters can reverse this process to recover the original contents of the lower layer message. For integrity protection, the gNB 324 uses K_{MACint} to compute a message authentication code that is appended to the transmitted data. In scenarios where a single K_{MAC} is generated, the same K_{MAC} is used to generate the keystream for encryption and to compute the message authentication code for integrity protection.

In some implementations, K_{MAC} is generated in parallel to the RRC and UP security keys within the key hierarchy 300. Here, the UE 304 and the gNB 324 generate K_{MAC} (e.g., a single K_{MAC} or K_{MACenc} and K_{MACint}) as part of the K_{RRC} and K_{UP} generation procedure. Alternatively, K_{MAC} generation may be implemented as a separate key family that exists alongside the RRC and UP key generation procedures, but maintains its own branch in the hierarchy (e.g., positioned at the bottom left side of the key hierarchy 300). In such examples, K_{MAC} generation (e.g., a single K_{MAC} or K_{MACenc} and K_{MACint}) is performed separately from the K_{RRC} and K_{UP} generation procedure.

The inputs to the KDF may depend on whether one or two lower layer security keys are generated, and whether the lower layer security key(s) are generated as part of the K_{RRC} and K_{UP} generation procedure or as a separate procedure(s). When generated as part of the K_{RRC} and K_{UP} generation procedure, the FC value, algorithm identity, and length of the algorithm identity used for generating K_{MAC} may be the same as the FC value, algorithm identity, and length of the algorithm identity used to generate K_{RRC} and K_{UP}. The algorithm type distinguisher(s) (e.g., one algorithm type distinguisher for generating one K_{MAC}, two algorithm type distinguishers for generating K_{MACenc} and K_{MACint}) and length of algorithm type distinguisher(s) (e.g., one length of algorithm type distinguisher for generating one K_{MAC}, two lengths of algorithm type distinguishers for generating K_{MACenc} and K_{MACint}) may be different from those used to generate K_{RRC} and K_{UP}. The generated K_{MAC} is on the same hierarchy level as K_{RRC} and K_{UP}. In the case of separate key derivation procedures, the FC value and algorithm type distinguisher(s) input to the KDF may be dedicated for K_{MAC} generation.

For example, when deriving a single K_{MAC} from K_{gNB} as a separate procedure from KRCC and K_{UP} generation, the gNB 324 determines (e.g., obtains, generates) an input S to the KDF using a set of parameters including, but not limited to, the K_{gNB} (e.g., a 256-bit input key KEY), an FC value, a lower layer flag P0, and a length of the lower layer flag L0. The FC value and the lower layer flag P0 may be dedicated for lower layer security key generation. For instance, the FC value may be 0x7F, 0x80, 0x81, etc., although any value associated with lower layer security can be used. The lower layer flag P0 may be, for example, 0x01, although any other value associated with lower layer security can be used. The KDF outputs a single lower layer security key K_{MAC}. For an algorithm key of length n bits, where n is less or equal to 256, the n least significant bits of the 256 bits of the KDF output (e.g., K_{MAC}) is used as the algorithm key (e.g., as input to the encryption and integrity algorithm).

When deriving K_{MACenc} and K_{MACint} as a separate procedure from K_{RRC} and K_{UP} generation, for each K_{MAC} derivation, the gNB 324 determines the input S to the KDF using the K_{gNB} and the set of parameters including the FC value, P0, L0, an algorithm type distinguisher P1, and a length of the algorithm type distinguisher L1. The FC value, P0, and P1 may each be dedicated for lower layer security key generation. For instance, the FC value may be 0x7F, 0x80, 0x81, etc., although any value associated with lower layer security can be used. The lower layer flag P0 may be, for example, 0x01, although any other value associated with lower layer security can be used. The input key KEY may be the 256-bit K_{gNB}. The output key K_{MACint} (associated with algorithm type distinguisher MAC-int-alg) can be used for integrity protection and verification, and the output key K_{MACenc} (associated with algorithm type distinguisher MAC-enc-alg) can be used for ciphering protection. For an algorithm key of length n bits, where n is less or equal to 256, the n least significant bits of the 256 bits of the KDF output (e.g., K_{MACenc}, K_{MACint}) are used as the algorithm key (e.g., as input to the encryption algorithm and integrity algorithm, respectively).

As shown in Table 1 below, the algorithm type distinguisher for MAC encryption algorithms (e.g., using K_{MACenc}) may be MAC-enc-alg and the algorithm type distinguisher for MAC integrity algorithms (e.g., using K_{MACint}) may be MAC-int-alg. The order of the algorithm type distinguishers in Table 1 may be reversed.

TABLE 1

| Algorithm Type Distinguisher | Value |
|---|---|
| MAC-enc-alg | 0x01 |
| MAC-int-alg | 0x02 |

In the case of K_{MAC} derivation as part of the K_{RRC} and K_{UP} derivation procedure, the input string S includes K_{gNB}, FC, P0, L0, P1, and L1, though these parameters may have different values than those used for the separate K_{MAC} generation procedure. For example, when deriving a single K_{MAC} for both encryption and integrity protection, the FC value may be 0x69, L0 may be 0x00 or 0x01, and L1 may be 0x00 or 0x01. As shown in Table 2 below, the algorithm type distinguisher may be N-MAC-alg and the length of the algorithm type distinguisher (e.g., the value) may be 0x07, although any other value associated with lower layer security can be used. However, the values 0x00 and 0x10 to 0xf0 are reserved for future use, and the values 0xfl to 0cff are reserved for private use.

TABLE 2

| Algorithm Type Distinguisher | Value |
|---|---|
| N-NAS-enc-alg | 0x01 |
| N-NAS-int-alg | 0x02 |
| N-RRC-enc-alg | 0x03 |
| N-RRC-int-alg | 0x04 |
| N-UP-enc-alg | 0x05 |
| N-UP-int-alg | 0x06 |
| N-MAC-alg | 0x07 |

The output key K_{MAC} (associated with algorithm type distinguisher N-MAC-alg) is used for both integrity and ciphering protection. For an algorithm key of length n bits, where n is less or equal to 256, the n least significant bits of the 256 bits of the KDF output (e.g., K_{MAC}) is used as the algorithm key (e.g., as input to the encryption and integrity algorithm).

When deriving K_{MACenc} and K_{MACint} as part of the K_{RRC} and K_{UP} derivation procedure, the input string S includes K_{gNB}, FC, P0, L0, P1, and L1. For example, the FC value may be 0x69, L0 may be 0x00 or 0x01, and L1 may be 0x00 or 0x01. As shown in Table 3 below, the algorithm type distinguisher may be N-MAC-enc-alg for K_{MACenc} and the length of the algorithm type distinguisher (e.g., the value) may be 0x07, while the algorithm type distinguisher for K_{MACint} may be N-MAC-int-alg with a length (e.g., value) of 0x10. Any other values associated with lower layer security can be used. However, the values 0x00 and 0x11 to 0xf0 may be reserved for future use, and the values 0xfl to Oxff may be reserved for private use. Additionally, the order of the algorithm type distinguishers in Table 3 may be exchanged.

TABLE 3

| Algorithm Type Distinguisher | Value |
|---|---|
| N-NAS-enc-alg | 0x01 |
| N-NAS-int-alg | 0x02 |
| N-RRC-enc-alg | 0x03 |
| N-RRC-int-alg | 0x04 |
| N-UP-enc-alg | 0x05 |
| N-UP-int-alg | 0x06 |
| N-MAC-enc-alg | 0x07 |
| N-MAC-int-alg | 0x10 |

The algorithm identity may be included in the four least significant bits of the octet. The two least significant bits of the four most significant bits are reserved for future use, and the two most significant bits of the most significant nibble are reserved for private use. The entire four most significant bits may be set to all zeros. The output key K_{MACint} (associated with algorithm type distinguisher N-MAC-int-alg=0x10) can be used for integrity and the output key K_{MACenc} (associated with algorithm type distinguisher N-MAC-enc-alg=0x07) may be used for ciphering protection. For an algorithm key of length n bits, where n is less or equal to 256, the n least significant bits of the 256 bits of the KDF output (e.g., K_{MACenc}, K_{MACint}) are used as the algorithm key (e.g., as input to the encryption algorithm and integrity algorithm, respectively).

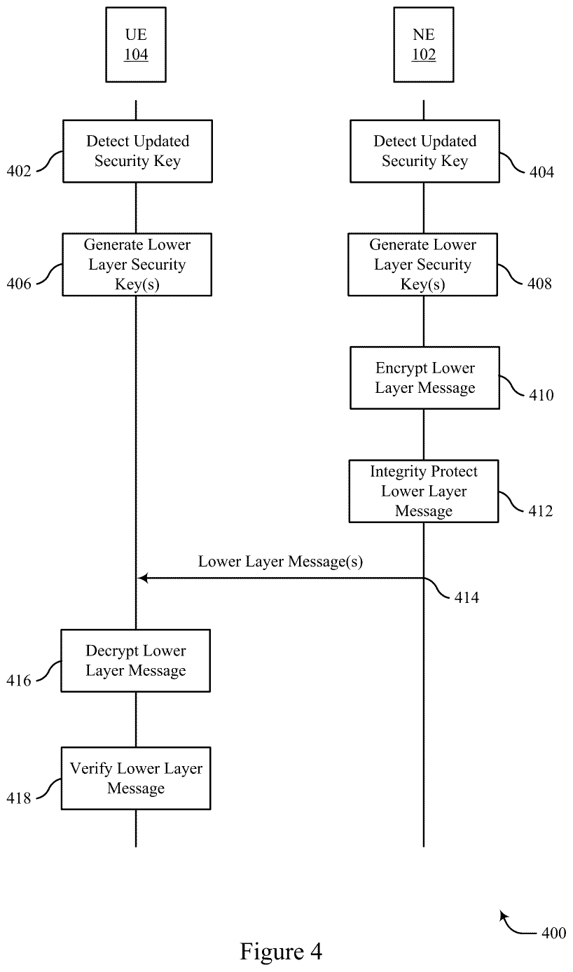

FIG. 4 illustrates an example signaling diagram 400 in accordance with aspects of the present disclosure. In some examples, the signaling diagram 400 implements or is implemented by aspects of the wireless communications system 100. For example, the signaling diagram 400 may implement or be implemented by a UE 104 and an NE102, which may be examples of the corresponding devices as described with reference to FIG. 1. Alternative examples of the following may be implemented, where some processes are performed in a different order than described or are not performed. For example, the processes performed by the NE 102 may be performed by the UE 104, and vice versa. In some cases, processes may include additional features not mentioned below, or further processes may be added.

At 402 and 404, the UE 104 and the NE 102, respectively, each detect that an updated security key is available. For example, the updated security key may be an updated gNB security key K_{gNB}. The UE 104 and the NE 102 may detect that an updated (e.g., new, refreshed) version of K_{gNB} is available during a handover procedure, when a new network connection is established by the UE 104, when the UE 104 moves between NEs 102 while in a connected mode (e.g., RRC_CONNECTED), or when the UE 104 transitions from an idle mode to the connected mode.

At 406, the UE 104 generates at least one lower layer security key for protection of lower layer messages using the updated security key. In some examples, the UE 104 may generate the at least one lower layer security key based on determining that a lower layer security feature (e.g., a MAC security feature) is enabled at the UE 104.

To generate the at least one lower layer security key, the UE 104 may derive the key(s) from the updated security key using a KDF. As inputs to the KDF, the UE 104 may provide one or more of the updated security key, an FC value, a lower layer flag, a length of the lower layer flag, an algorithm identity, a length of the algorithm identity, an algorithm type distinguisher, or a length of the algorithm type distinguisher. The inputs to the KDF may be based on whether the UE 104 is to generate a single lower layer security key for both encryption and integrity protection, or separate lower layer security keys for encryption and integrity protection. For example, the UE 104 may generate a lower layer encryption security key using a first algorithm type distinguisher and a first length of the first algorithm type distinguisher, and a lower layer integrity security key using a second algorithm type distinguisher and a second length of the second algorithm type distinguisher. The first algorithm type distinguisher and the second algorithm type distinguisher may be different.

Alternatively, when the UE 104 generates a single lower layer security key for both encryption and integrity protection, the UE 104 may only provide, as inputs to the KDF, an FC, a lower layer flag, and a length of the lower flag (e.g., and may not input an algorithm type distinguisher or a length of an algorithm type distinguisher).

In some examples, the UE 104 generates the lower layer security key(s) as part of a procedure for generating RRC and UP security keys. Here, the FC value, algorithm identity, and length of the algorithm identity used for generating the lower layer security key(s) may be the same as the FC value, algorithm identity, and length of the algorithm identity used in generating the RRC and UP security keys, while the algorithm type distinguisher(s) and length of algorithm type distinguisher(s) may be different from those used in generating the RRC and UP security keys. In other examples, the UE 104 may generate the lower layer security key(s) separately from such a procedure. In such examples, the FC value, lower layer flag, and algorithm type distinguisher(s) may be different from those used in generating the RRC and UP security keys.

At 408, the NE 102 also generates at least one lower layer security key for protection of lower layer messages using the updated security key. In some examples, the NE 102 may generate the at least one lower layer security key based on determining that a lower layer security feature (e.g., a MAC security feature) is enabled at the NE 102.

To generate the at least one lower layer security key, the NE 102 may derive the key(s) from the updated security key using a KDF. As inputs to the KDF, the NE 102 may provide one or more of the updated security key, an FC value, a lower layer flag, a length of the lower layer flag, an algorithm identity, a length of the algorithm identity, an algorithm type distinguisher, or a length of the algorithm type distinguisher. The inputs to the KDF may be based on whether the NE 102 is to generate a single lower layer security key for both encryption and integrity protection, or separate lower layer security keys for encryption and integrity protection. For example, the NE 102 may generate a lower layer encryption security key using a first algorithm type distinguisher and a first length of the first algorithm type distinguisher, and a lower layer integrity security key using a second algorithm type distinguisher and a second length of the second algorithm type distinguisher. The first algorithm type distinguisher and the second algorithm type distinguisher may be different. Alternatively, when the NE 102 generates a single lower layer security key, the NE 102 may only provide, as inputs to the KDF, an FC, a lower layer flag, and a length of the lower flag (e.g., and may not input an algorithm type distinguisher or a length of an algorithm type distinguisher).

In some examples, the NE 102 generates the lower layer security key(s) as part of a procedure for generating RRC and UP security keys. Here, the FC value, algorithm identity, and length of the algorithm identity used for generating the lower layer security key(s) may be the same as the FC value, algorithm identity, and length of the algorithm identity used in generating the RRC and UP security keys, while the algorithm type distinguisher(s) and length of algorithm type distinguisher(s) may be different from those used in generating the RRC and UP security keys. In other examples, the NE 102 may generate the lower layer security key(s) separately from such a procedure. In such examples, the FC value, lower layer flag, and algorithm type distinguisher(s) may be different from those used in generating the RRC and UP security keys.

It should be noted that the key generation performed at 406 and 408 by the UE 104 and the NE 102, respectively, use the same key derivation process, including the same inputs to the KDF. For example, the quantity of lower layer security key(s) (e.g., one or two) generated by the UE 104 and the NE 102 are the same, the inputs provided to the KDF are the same, and the lower layer security keys output by the KDF are the same, ensuring that the UE 104 and the NE 102 are able to successfully encrypt/decrypt and verify integrity of lower layer messages exchanged with one another. In the example of FIG. 4, the UE 104 and the NE 102 may each generate two lower layer security keys: a lower layer encryption security key and a lower layer integrity protection security key.

At 410, the NE 102 encrypts at least one lower layer message (e.g., MAC-CE) using the lower layer encryption security key. For example, the NE 102 may use the lower layer encryption security key and an encryption algorithm (e.g., a lower layer encryption algorithm) to generate a keystream, and may XOR the keystream with the content of the at least one lower layer message to produce ciphertext.

At 412, the NE 102 protects integrity of the at least one lower layer message using the lower layer integrity protection security key. For example, the NE 102 may use the lower layer integrity protection security key, an integrity algorithm (e.g., a lower layer integrity algorithm), and the contents of the at least one lower layer message to generate a message authentication code appended to the at least one lower layer message.

At 414, the NE 102 transmits, and the UE 104 receives, the encrypted and protected at least one lower layer message.

At 416, the UE 104 decrypts the at least one lower layer message using the lower layer encryption security key. For example, the UE 104 may utilize an inverse version of the lower layer encryption algorithm to generate a keystream and may reverse XOR the keystream to extract the contents of the at least one lower layer message.

At 418, the UE 104 verifies the authenticity of the at least one lower layer message using the lower layer integrity security key. For example, the UE 104 generates a message authentication code using the lower layer integrity protection security key, the lower layer integrity algorithm, and the contents of the at least one lower layer message. The UE 104 compares the generated message authentication code with the message authentication code appended to the at least one lower layer message. If the two codes match, the UE 104 can verify that the at least one lower layer message is authentic and its integrity is intact.

It should be noted that, although the signaling diagram 400 illustrates K_{MAC} generation and encryption of a lower layer message transmitted by the NE 102 and received and decrypted by the UE 104, alternative implementations are supported by the described techniques and the examples discussed herein are not to be construed as limiting. For example, the described techniques also provide for K_{MAC} generation and encryption of a lower layer message at the UE 104, where the UE 104 transmits the lower layer message to the NE 102, which decrypts and performs integrity verification of the lower layer message.

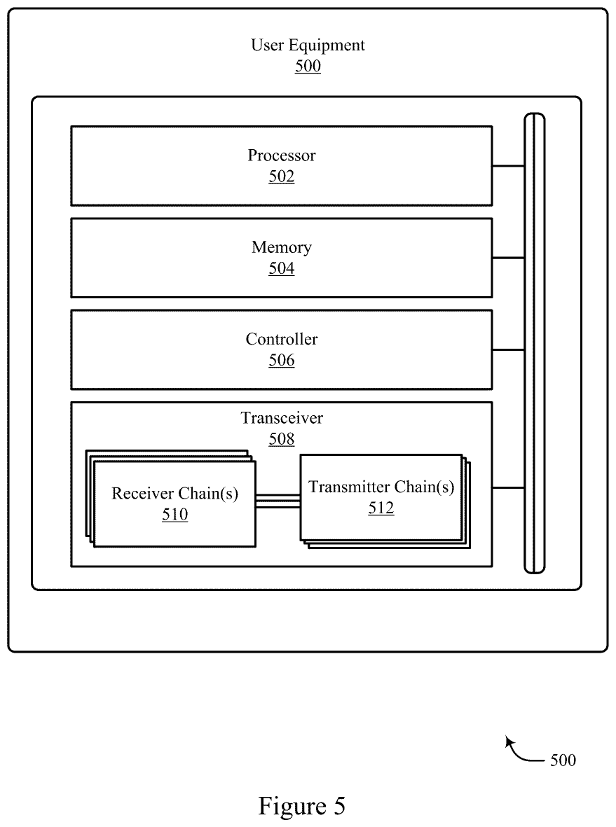

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field-programmable gate-array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for detecting that an updated security key is available, generating, using the updated security key, at least one lower layer security key for protection of lower layer messages, and receiving a lower layer message using the at least one lower layer security key.

Additionally, the UE 500 may be configured to support any one or combination of generating the at least one lower layer security key includes providing, as inputs to a key derivation function, one or more of an FC value, a lower layer flag, a length of the lower layer flag, an algorithm type distinguisher, or a length of the algorithm type distinguisher, and deriving the at least one lower layer security key from the updated security key using the key derivation function. Additionally, or alternatively, the UE 500 may be configured to support the at least one lower layer security key includes a first lower layer security key and a second lower layer security key, and generating the at least one lower layer security key includes generating the first lower layer security key using a first algorithm type distinguisher and a first length of the first algorithm type distinguisher, and generating the second lower layer security key using a second algorithm type distinguisher and a second length of the second algorithm type distinguisher. Additionally, or alternatively, the UE 500 may be configured to support receiving the lower layer message includes decrypting the lower layer message using the first lower layer security key, and verifying authenticity of the lower layer message using the second lower layer security key. Additionally, or alternatively, the UE 500 may be configured to support the at least one lower layer security key includes a single lower layer security key, and receiving the lower layer message includes decrypting the lower layer message using the single lower layer security key, and verifying authenticity of the lower layer message using the single lower layer security key. Additionally, or alternatively, the UE 500 may be configured to support generating the at least one lower layer security key separately from a procedure for RRC and UP key generation. Additionally, or alternatively, the UE 500 may be configured to support generating the at least one lower layer security key as part of a procedure for RRC and UP key generation. Additionally, or alternatively, the UE 500 may be configured to support generating the at least one lower layer security key based on a determination that a MAC security feature is enabled at the UE. Additionally, or alternatively, the updated security key includes an updated gNB security key.

Additionally, or alternatively, the UE 500 may support at least one memory (e.g., the memory 504) and at least one processor (e.g., the processor 502) coupled with the at least one memory and configured to cause the UE to detect that an updated security key is available, generate, using the updated security key, at least one lower layer security key for protection of lower layer messages, and receive a lower layer message using the at least one lower layer security key.

Additionally, the UE 500 may be configured to support any one or combination of the at least one processor configured to cause the UE 500 to generate the at least one lower layer security key, provide, as inputs to a key derivation function, one or more of an FC value, a lower layer flag, a length of the lower layer flag, an algorithm type distinguisher, or a length of the algorithm type distinguisher, and derive the at least one lower layer security key from the updated security key using the key derivation function. Additionally, or alternatively, the UE 500 may be configured to support the at least one lower layer security key includes a first lower layer security key and a second lower layer security key, and to generate the at least one lower layer security key, the at least one processor is configured to cause the UE 500 to generate the first lower layer security key using a first algorithm type distinguisher and a first length of the first algorithm type distinguisher, and generate the second lower layer security key using a second algorithm type distinguisher and a second length of the second algorithm type distinguisher. Additionally, or alternatively, the UE 500 may be configured to support the at least one processor configured to cause the UE 500 to receive the lower layer message, decrypt the lower layer message using the first lower layer security key, and verify authenticity of the lower layer message using the second lower layer security key. Additionally, or alternatively, the UE 500 may be configured to support the at least one lower layer security key includes a single lower layer security key, and to receive the lower layer message, the at least one processor is configured to cause the UE 500 to decrypt the lower layer message using the single lower layer security key, and verify authenticity of the lower layer message using the single lower layer security key. Additionally, or alternatively, the UE 500 may be configured to support the at least one processor configured to cause the UE 500 to generate the at least one lower layer security key separately from a procedure for RRC and UP key generation. Additionally, or alternatively, the UE 500 may be configured to support the at least one processor configured to cause the UE 500 to generate the at least one lower layer security key as part of a procedure for RRC and UP key generation. Additionally, or alternatively, the UE 500 may be configured to support the at least one processor configured to cause the UE 500 to generate the at least one lower layer security key based on a determination that a MAC security feature is enabled at the UE. Additionally, or alternatively, the updated security key includes an updated gNB security key.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

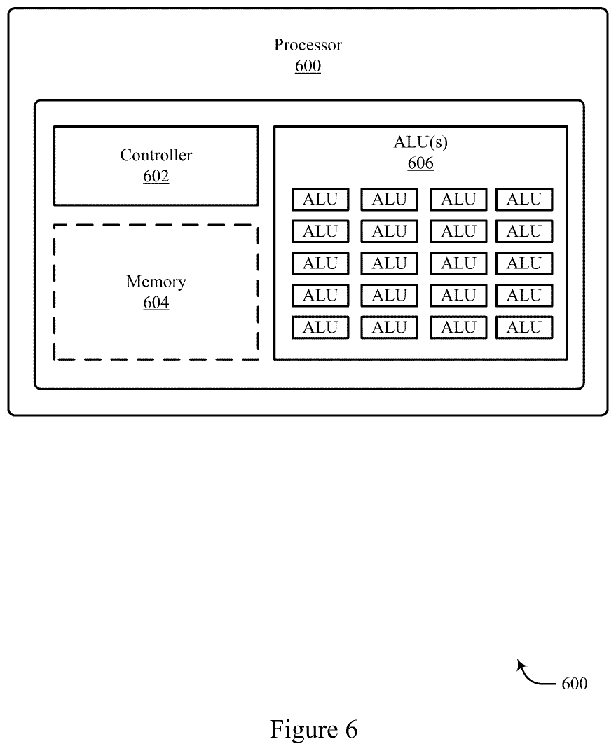

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to detect that an updated security key is available, generate, using the updated security key, at least one lower layer security key for protection of lower layer messages, and receive a lower layer message using the at least one lower layer security key.

Additionally, the processor 600 may be configured to or operable to support any one or combination of to generate the at least one lower layer security key, provide, as inputs to a key derivation function, one or more of a FC value, a lower layer flag, a length of the lower layer flag, an algorithm type distinguisher, or a length of the algorithm type distinguisher, and derive the at least one lower layer security key from the updated security key using the key derivation function. Additionally, or alternatively, the processor 600 may be configured to support the at least one lower layer security key includes a first lower layer security key and a second lower layer security key, and to generate the at least one lower layer security key, generate the first lower layer security key using a first algorithm type distinguisher and a first length of the first algorithm type distinguisher, and generate the second lower layer security key using a second algorithm type distinguisher and a second length of the second algorithm type distinguisher. Additionally, or alternatively, the processor 600 may be configured to support to receive the lower layer message, decrypt the lower layer message using the first lower layer security key, and verify authenticity of the lower layer message using the second lower layer security key. Additionally, or alternatively, the processor 600 may be configured to support the at least one lower layer security key includes a single lower layer security key, and to receive the lower layer message, decrypt the lower layer message using the single lower layer security key, and verify authenticity of the lower layer message using the single lower layer security key. Additionally, or alternatively, the processor 600 may be configured to support generating the at least one lower layer security key separately from a procedure for RRC and UP key generation. Additionally, or alternatively, the processor 600 may be configured to support generating the at least one lower layer security key as part of a procedure for RRC and UP key generation. Additionally, or alternatively, the processor 600 may be configured to support generating the at least one lower layer security key based on a determination that a MAC security feature is enabled at the processor. Additionally, or alternatively, the processor 600 may be configured to support the updated security key includes an updated gNB security key.

Additionally, or alternatively, the processor 600 may support wireless communication in accordance with examples as disclosed herein. The processor 600 may be configured to or operable to support at least one controller (e.g., the controller 602) coupled with at least one memory (e.g., the memory 604) and configured to cause the processor to detect that an updated security key is available, generate, using the updated security key, at least one lower layer security key for protection of lower layer messages, and transmit a lower layer message using the at least one lower layer security key.

Additionally, the processor 600 may be configured to or operable to support any one or combination of to generate the at least one lower layer security key, derive the at least one lower layer security key from the updated security key using a key derivation function. Additionally, or alternatively, the processor 600 may be configured to support to derive the at least one lower layer security key, provide, as inputs to the key derivation function, one or more of a FC value, a lower layer flag, a length of the lower layer flag, an algorithm type distinguisher, or a length of the algorithm type distinguisher. Additionally, or alternatively, the processor 600 may be configured to support the at least one lower layer security key includes a first lower layer security key and a second lower layer security key, and to generate the at least one lower layer security key, generate the first lower layer security key using a first algorithm type distinguisher and a first length of the first algorithm type distinguisher, and generate the second lower layer security key using a second algorithm type distinguisher and a second length of the second algorithm type distinguisher. Additionally, or alternatively, the processor 600 may be configured to support to transmit the lower layer message, encrypting the lower layer message using the first lower layer security key, and integrity protecting the lower layer message using the second lower layer security key. Additionally, or alternatively, the processor 600 may be configured to support the at least one lower layer security key includes a single lower layer security key, and to transmit the lower layer message, encrypt the lower layer message using the single lower layer security key, and integrity protect the lower layer message using the single lower layer security key. Additionally, or alternatively, the processor 600 may be configured to support generating the at least one lower layer security key separately from a procedure for RRC and UP key generation. Additionally, or alternatively, the processor 600 may be configured to support generating the at least one lower layer security key as part of a procedure for RRC and UP key generation. Additionally, or alternatively, the processor 600 may be configured to support generating the at least one lower layer security key based on a determination that a MAC security feature is enabled at the NE. Additionally, or alternatively, the processor 600 may be configured to support the updated security key includes an updated gNB security key.

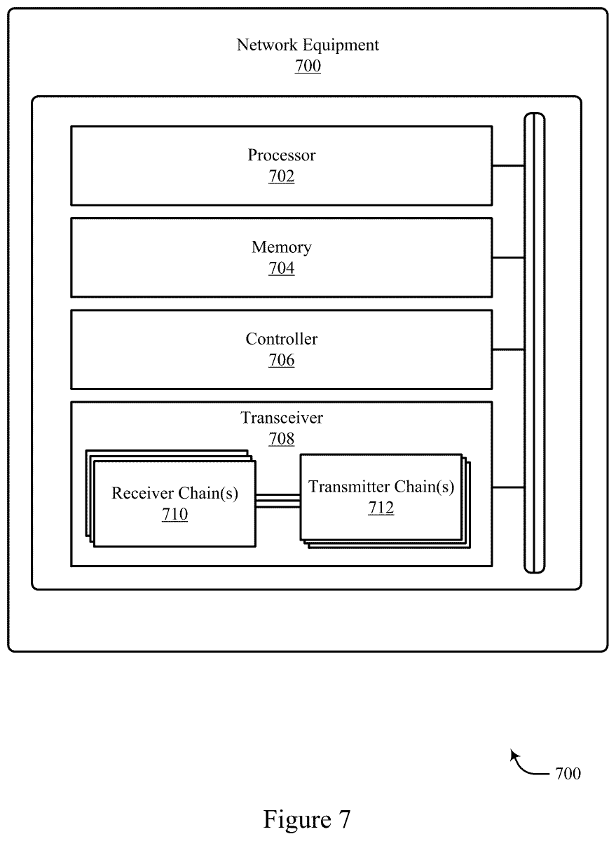

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for detecting that an updated security key is available, generating, using the updated security key, at least one lower layer security key for protection of lower layer messages, and transmitting a lower layer message using the at least one lower layer security key.

Additionally, the NE 700 may be configured to or operable to support any one or combination of generating the at least one lower layer security key includes deriving the at least one lower layer security key from the updated security key using a key derivation function. Additionally, or alternatively, the NE 700 may be configured to support deriving the at least one lower layer security key includes providing, as inputs to the key derivation function, one or more of a FC value, a lower layer flag, a length of the lower layer flag, an algorithm type distinguisher, or a length of the algorithm type distinguisher. Additionally, or alternatively, the NE 700 may be configured to support the at least one lower layer security key includes a first lower layer security key and a second lower layer security key, and generating the at least one lower layer security key includes generating the first lower layer security key using a first algorithm type distinguisher and a first length of the first algorithm type distinguisher, and generating the second lower layer security key using a second algorithm type distinguisher and a second length of the second algorithm type distinguisher. Additionally, or alternatively, the NE 700 may be configured to support transmitting the lower layer message, encrypting the lower layer message using the first lower layer security key, and integrity protecting the lower layer message using the second lower layer security key. Additionally, or alternatively, the NE 700 may be configured to support the at least one lower layer security key includes a single lower layer security key, and transmitting the lower layer message includes encrypting the lower layer message using the single lower layer security key, and integrity protecting the lower layer message using the single lower layer security key. Additionally, or alternatively, the NE 700 may be configured to support generating the at least one lower layer security key separately from a procedure for RRC and UP key generation. Additionally, or alternatively, the NE 700 may be configured to support generating the at least one lower layer security key as part of a procedure for RRC and UP key generation. Additionally, or alternatively, the NE 700 may be configured to support generating the at least one lower layer security key based on a determination that a MAC security feature is enabled at the NE. Additionally, or alternatively, the NE 700 may be configured to support the updated security key includes an updated gNB security key.

Additionally, or alternatively, the NE 700 may support at least one memory (e.g., the memory 704) and at least one processor (e.g., the processor 702) coupled with the at least one memory and configured to cause the NE to detect that an updated security key is available, generate, using the updated security key, at least one lower layer security key for protection of lower layer messages, and transmit a lower layer message using the at least one lower layer security key.

Additionally, the NE 700 may be configured to support any one or combination of to generate the at least one lower layer security key, derive the at least one lower layer security key from the updated security key using a key derivation function. Additionally, or alternatively, the NE 700 may be configured to support to derive the at least one lower layer security key, provide, as inputs to the key derivation function, one or more of a FC value, a lower layer flag, a length of the lower layer flag, an algorithm type distinguisher, or a length of the algorithm type distinguisher. Additionally, or alternatively, the NE 700 may be configured to support the at least one lower layer security key includes a first lower layer security key and a second lower layer security key, and to generate the at least one lower layer security key, generate the first lower layer security key using a first algorithm type distinguisher and a first length of the first algorithm type distinguisher, and generate the second lower layer security key using a second algorithm type distinguisher and a second length of the second algorithm type distinguisher. Additionally, or alternatively, the NE 700 may be configured to support to transmit the lower layer message, encrypting the lower layer message using the first lower layer security key, and integrity protecting the lower layer message using the second lower layer security key. Additionally, or alternatively, the NE 700 may be configured to support the at least one lower layer security key includes a single lower layer security key, and to transmit the lower layer message, encrypt the lower layer message using the single lower layer security key, and integrity protect the lower layer message using the single lower layer security key. Additionally, or alternatively, the NE 700 may be configured to support generating the at least one lower layer security key separately from a procedure for RRC and UP key generation. Additionally, or alternatively, the NE 700 may be configured to support generating the at least one lower layer security key as part of a procedure for RRC and UP key generation. Additionally, or alternatively, the NE 700 may be configured to support generating the at least one lower layer security key based on a determination that a MAC security feature is enabled at the NE. Additionally, or alternatively, the NE 700 may be configured to support the updated security key includes an updated gNB security key.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., an LNA) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

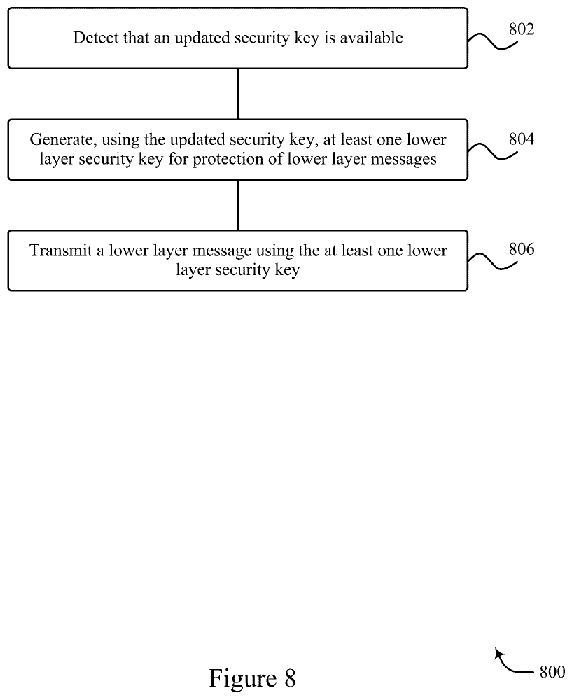

FIG. 8 illustrates a flowchart of a method 800 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 802, the method may include detecting that an updated security key is available. The operations of 802 may be performed in accordance with examples as described herein. In some implementations, aspects of the operations of 802 may be performed by an NE as described with reference to FIG. 7.

At 804, the method may include generating, using the updated security key, at least one lower layer security key for protection of lower layer messages. The operations of 804 may be performed in accordance with examples as described herein. In some implementations, aspects of the operations of 804 may be performed by an NE as described with reference to FIG. 7.

At 806, the method may include transmitting a lower layer message using the at least one lower layer security key. The operations of 806 may be performed in accordance with examples as described herein. In some implementations, aspects of the operations of 806 may be performed an NE as described with reference to FIG. 7.

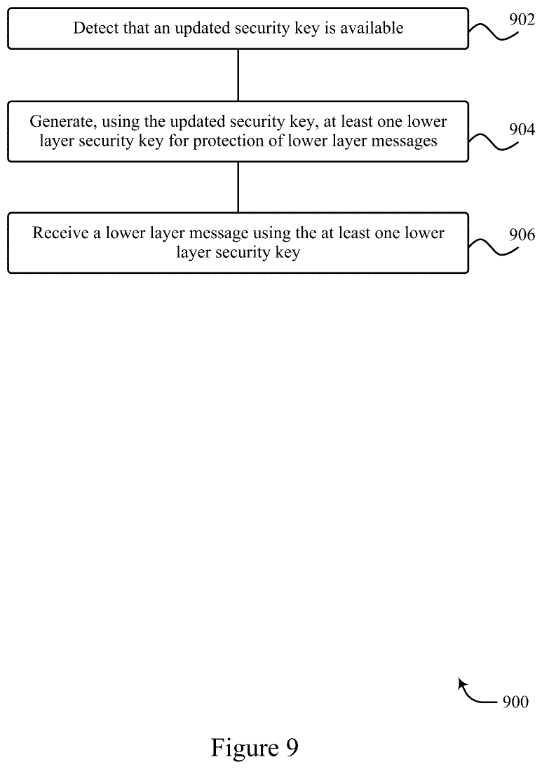

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include detecting that an updated security key is available. The operations of 902 may be performed in accordance with examples as described herein. In some implementations, aspects of the operations of 902 may be performed by a UE as described with reference to FIG. 5.

At 904, the method may include generating, using the updated security key, at least one lower layer security key for protection of lower layer messages. The operations of 904 may be performed in accordance with examples as described herein. In some implementations, aspects of the operations of 904 may be performed by a UE as described with reference to FIG. 5.

At 906, the method may include receiving a lower layer message using the at least one lower layer security key. The operations of 906 may be performed in accordance with examples as described herein. In some implementations, aspects of the operations of 906 may be performed a UE as described with reference to FIG. 5.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network entity (NE) for wireless communication, comprising:
at least one memory; and
at least one processor coupled with the at least one memory and operable to cause the NE to:
detect that an updated security key is available;
generate, using the updated security key, at least one lower layer security key for protection of lower layer messages; and
transmit a lower layer message using the at least one lower layer security key.

2. The NE of claim 1, wherein, to generate the at least one lower layer security key, the at least one processor is operable to cause the NE to derive the at least one lower layer security key from the updated security key using a key derivation function.

3. The NE of claim 2, wherein, to derive the at least one lower layer security key, the at least one processor is operable to cause the NE to provide, as inputs to the key derivation function, one or more of a function code (FC) value, a lower layer flag, a length of the lower layer flag, an algorithm type distinguisher, or a length of the algorithm type distinguisher.

4. The NE of claim 1, wherein the at least one lower layer security key comprises a first lower layer security key and a second lower layer security key, and wherein, to generate the at least one lower layer security key, the at least one processor is further operable to cause the NE to:
generate the first lower layer security key using a first algorithm type distinguisher and a first length of the first algorithm type distinguisher; and
generate the second lower layer security key using a second algorithm type distinguisher and a second length of the second algorithm type distinguisher.

5. The NE of claim 4, wherein, to transmit the lower layer message, the at least one processor is further operable to cause the NE to:
encrypt the lower layer message using the first lower layer security key; and
integrity protect the lower layer message using the second lower layer security key.

6. The NE of claim 1, wherein the at least one lower layer security key comprises a single lower layer security key, and wherein, to transmit the lower layer message, the at least one processor is further operable to cause the NE to:
encrypt the lower layer message using the single lower layer security key; and
integrity protect the lower layer message using the single lower layer security key.

7. The NE of claim 1, wherein the at least one lower layer security key is generated separately from a procedure for radio resource control (RRC) and user plane (UP) key generation.

8. The NE of claim 1, wherein the at least one lower layer security key is generated as part of a procedure for radio resource control (RRC) and user plane (UP) key generation.

9. The NE of claim 1, wherein the at least one lower layer security key is generated based at least in part on a determination that a medium access control (MAC) security feature is enabled at the NE.

10. The NE of claim 1, wherein the updated security key comprises an updated next generation NodeB (gNB) security key.

11. A user equipment (UE) for wireless communication, comprising:
at least one memory; and
at least one processor coupled with the at least one memory and operable to cause the UE to:
detect that an updated security key is available;
generate, using the updated security key, at least one lower layer security key for protection of lower layer messages; and
receive a lower layer message using the at least one lower layer security key.

12. The UE of claim 11, wherein, to generate the at least one lower layer security key, the at least one processor is operable to cause the UE to:
provide, as inputs to a key derivation function, one or more of a function code (FC) value, a lower layer flag, a length of the lower layer flag, an algorithm type distinguisher, or a length of the algorithm type distinguisher; and
derive the at least one lower layer security key from the updated security key using the key derivation function.

13. The UE of claim 11, wherein the at least one lower layer security key comprises a first lower layer security key and a second lower layer security key, and wherein, to generate the at least one lower layer security key, the at least one processor is further operable to cause the UE to:
generate the first lower layer security key using a first algorithm type distinguisher and a first length of the first algorithm type distinguisher; and
generate the second lower layer security key using a second algorithm type distinguisher and a second length of the second algorithm type distinguisher.

14. The UE of claim 13, wherein, to receive the lower layer message, the at least one processor is further operable to cause the UE to:
decrypt the lower layer message using the first lower layer security key; and
verify authenticity of the lower layer message using the second lower layer security key.

15. The UE of claim 11, wherein the at least one lower layer security key comprises a single lower layer security key, and wherein, to receive the lower layer message, the at least one processor is further operable to cause the UE to:
decrypt the lower layer message using the single lower layer security key; and
verify authenticity of the lower layer message using the single lower layer security key.

16. The UE of claim 11, wherein the at least one lower layer security key is generated separately from a procedure for radio resource control (RRC) and user plane (UP) key generation.

17. The UE of claim 11, wherein the at least one lower layer security key is generated as part of a procedure for radio resource control (RRC) and user plane (UP) key generation.

18. The UE of claim 11, wherein the at least one lower layer security key is generated based at least in part on a determination that a medium access control (MAC) security feature is enabled at the UE.

19. A method performed by a user equipment (UE), comprising:
detecting that an updated security key is available;
generating, using the updated security key, at least one lower layer security key for protection of lower layer messages; and
receiving a lower layer message using the at least one lower layer security key.

20. A method performed by a network equipment (NE), comprising:
detecting that an updated security key is available;
generating, using the updated security key, at least one lower layer security key for protection of lower layer messages; and
transmitting a lower layer message using the at least one lower layer security key.
